(19) United States
(12) Patent Application Publication
(10) Pub. No.: US 2005/0041992 A1
(43) Pub. Date: Feb. 24, 2005

(54) Electric contact member applying voltage to charger, process cartridge, and image forming apparatus

(75) Inventors: Akiyoshi Fujita, Shizuoka-ken (JP); Atsushi Numagami, Kanagawa-ken (JP); Takahito Ueno, Shizuoka-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/671,520

(22) Filed: Sep. 29, 2003

(30) Foreign Application Priority Data
Sep. 30, 2002 (JP) 2002-285107 (PAT.

(51) Int. Cl. G03G 15/00

(52) U.S. Cl. 399/89

(57) ABSTRACT

The present invention relates to an electric contact member applying a voltage from a voltage applying means to a charger reciprocally moving in a longitudinal direction of an image carrier, comprising a securing portion electrically connected to a side of the voltage applying means, a moving portion reciprocally movable connected electrically to a side of the charger and a buffer portion formed between the securing portion and the moving portion.

### BACKGROUND OF THE INVENTION

1. Field of the Invention

This invention relates to an image forming apparatus such as, e.g., electrophotographic copier, and electrophotographic printer, to a process cartridge detachably attached to the image forming apparatus body, and to an electric contact point member suitable to be used in those apparatuses.

Herein, the image forming apparatus is to form images on recording media using electrophotographic image forming process. The image forming apparatus includes, e.g., electrophotographic copier, electrophotographic printer (LED printer, laser beam printer, etc.), electrophotographic facsimile machine, and electrophotographic word processor.

The process cartridge is made of a cartridge integrating an electrophotographic photosensitive drum as an image carrier with at least one of charging means, developing means, and cleaning means, and the cartridge is used as detachably attached to the image forming apparatus body.

2. Description of Related Art

Image forming apparatuses such as photocopiers, printers, and facsimile machines using an transfer type electrophotographic method are conventionally constituted of a photosensitive body as an image carrier typically made in a rotary drum shape, a charging device (charging process) for processing uniformly charging the photosensitive body at a prescribed polarity and potential, an exposing device (exposing process) as information writing means forming electrophotographic latent images on the photosensitive body processed with charging, a developing device (developing process) for visualizing the electrophotographic latent images formed on the photosensitive body with a developing agent, a transferring device (transferring process) for transferring the developing agent images onto a transfer material such as a paper from the surface of the photosensitive body, a cleaning device (cleaning process) cleaning the photosensitive body surface by removing the developing agent remaining more or less on the photosensitive body after the transfer process, and a fixing device (fixing process) for fixing the developing agent image on the transfer material, and the photosensitive body serves for image formation upon applying repeatedly the electrophotographic process (charging, exposing, developing, transferring, cleaning, and fixing).

Although the developing agent remaining on the photosensitive body after the transfer process is removed from the surface of the photosensitive body by the cleaning device and is reserved in the cleaning device as the waste developing agent, it is desirable to nullify such a waste developing agent in terms of environment preservation and effective use of resources. An image forming apparatus returning the remaining developing agent image, or namely so-called-the waste developing agent collected at the cleaning device and reutilizing the agent, has been known.

An image forming apparatus of non-cleaner type has been proposed in which the remaining developing agent image on the photosensitive body after the transfer process is removed by cleaning concurrently done with the development in the developing device and is collected to be reused. A structure, inter alia, has been proposed in which a developing agent charging amount controlling means is used as a charger (developing agent charging means) in the image forming apparatus as to control the charging amount of the developing agent to collect the developing agent at the developing device and reuse the agent.

However, in the image forming apparatus using the developing agent charging amount controlling means as the prior art, where an immobilized blush shape member is used as the developing agent charging amount controlling means and where the triboelectricity of the remaining developing agent image is controlled to be a proper charging amount with a normal polarity, overcharging of the remaining developing agent image may occur locally. If such overcharging of the remaining developing agent image occurs, the mirror reflection force between the photosensitive body and the overcharged developing agent becomes too strong, so that the remaining developing agent image cannot be attached even with a contact charging device, cannot be collected with the developing apparatus, and cannot be transferred with a transferring device, and consequently, the remaining developing agent image is adhered to the surface of the photosensitive body, thereby forming defective images.

It is turned out that this phenomenon occurs from a causation that the immobilized blush serving as the developing agent charging amount controlling means is positioned continuously at a fixed location on the photosensitive body. That is, where the developing agent charging amount controlling means operates with irregular resistance, overcharging or inadequate charging always occurs at the same location on the photosensitive body. At the charged portion, problems on localized overcharging or melting of the remaining developing agent image may occur. At the inadequate charging portion, the contact charging member may get dirty due to attachment of the developing agent because the remaining developing agent image cannot be charged adequately.

According to recent various needs on the users, the above problems are further raised because the remaining developing agent image in a large amount tend to occur at a time from continuous printing operation of high printing rate images such as photographic images or multiple developing methods on the photosensitive body in association with rendering the images multicolored.

As a similar case, there raises a case that particles such as dusts, floating developing agents, and charged products may attached onto a roller surface according to use of a long period because the charging roller used as a charger for the photosensitive body rotates in contact with the photosensitive body.

It is to be noted that Japanese Patent Application Publication 2001-215,799 discloses that a developing agent charging amount controlling means as the charger is moved reciprocally in the longitudinal direction of the photosensitive body, but a proper electric contact member is sought to apply a stable voltage to the developing agent charging amount controlling means moving reciprocally.

### SUMMARY OF THE INVENTION

It is an object of the invention to provide an electric contact point member stably applying voltage to a charger moving reciprocally, a process cartridge, and an image forming apparatus.

It is another object of the invention to provide an electric contact point member, a process cartridge, and an image forming apparatus, not suffering from charging defects or image defects.

It is yet another object of the invention to provide an electric contact point member, a process cartridge, and an image forming apparatus so that a charger can feed a proper charge amount to the remaining developing agent on an image carrier.

It is still another object of the invention to provide an electric contact point member, a process cartridge, and an image forming apparatus preventing developing agent collection defect from occurring out of an image carrier or preventing the charging means from getting dirty upon attachments of the developing agent, caused by an improper charge amount of the remaining developing agent on the image carrier.

It is still further object of the invention to provide a process cartridge and an image forming apparatus utilizing an advantage from a non-cleaner system.

### BRIEF DESCRIPTION OF THE DRAWINGS

FIG. 1 is an illustration showing the whole structure of a laser beam printer as an embodiment of a multicolor electrophotographic image forming apparatus;

FIG. 2 is a cross section showing a process cartridge and a developing agent supplying container;

FIG. 3 is an appearance perspective view showing an image forming apparatus;

FIG. 4 is a cross section along a longitudinal direction showing a process cartridge;

FIG. 5 is a cross section along a longitudinal direction showing a developing agent supplying container;

FIG. 6 is a diagram along a longitudinal direction showing a charging unit;

FIG. 7 is a cross section showing the charging unit adapting a non-cleaner system;

FIG. 8 is a perspective view showing the charging unit adapting the non-cleaner system;

FIG. 9 is a perspective view showing a feeding contact point member and the vicinity of the charging unit; and

FIG. 10 is a perspective view showing a feeding metal plate for blush feeding and a blush feeding contact point member.

### DETAILED DESCRIPTION OF THE PREFERRED EMBODIMENTS

Now, embodiments of an electric contact point member, a process cartridge, and an image forming apparatus, according to the invention are described. In the description below, the term “longitudinal direction” is a direction perpendicular to the conveyance direction of the recording medium and is the same direction to the axial direction of the image carrier. The term “right and left” is the right and left direction when seen from the conveyance direction of the recording medium. The term “up and down” is the up and down direction when the cartridge is mounted.

[Description of the Whole Image Forming Apparatus]

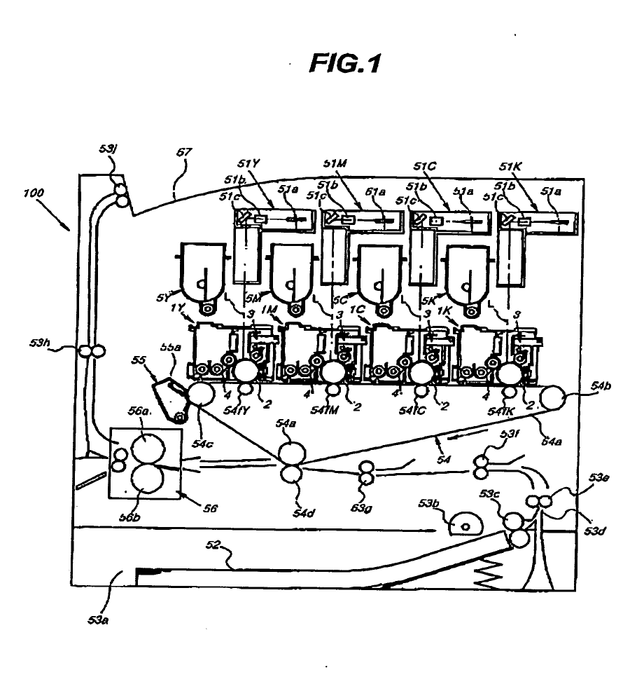

Referring to FIG. 1, the outline of the whole structure of the image forming apparatus is described. FIG. 1 is an illustration showing the whole structure of a laser beam printer as an embodiment of a multicolor electrophotographic image forming apparatus.

In the image forming portion of the multicolor laser beam printer, four process cartridges 1Y, 1M, 1C, 1K (yellow, magenta, cyan, black), each having a photosensitive drum (electrophotographic photosensitive body) 2 as an example of the image carrier, and exposing devices 51Y, 51M, 51C, 51K (laser beam optical scanning system) arranged above the process cartridges 1Y, 1M, 1C, 1K as corresponding to the respective colors are disposed parallel. A feeding device for feeding out a recording medium 52, an intermediate transfer unit 54 for transferring developing agent formed on the photosensitive drum 2, and a secondary transfer roller 54d for transferring the developing agent to the recording medium 52 from the intermediate transfer unit 54 are disposed below the image forming apparatus. A fixing device 56 for fixing the image on the recording medium 52 to which the developing agent image is transferred, and a delivering means for delivering the recording medium 52 out of the apparatus and for stacking the medium are also disposed. As the recording medium 52, exemplified are paper, OHP sheets, and fabrics.

The image forming apparatus of this embodiment is of an apparatus of non-cleaner system, and the remaining developing agent image remaining on the photosensitive drum 2 is reserved in the developing means, and no cleaner for collecting and reserving the remaining developing agent image is not disposed in the process cartridge.

[Feeding Section]

Structures of the respective sections of the image forming apparatus are described in detail sequentially. The feeding section is for feeding the recording medium 52 to the image forming section, and is constituted mainly of a feeding cassette 53a containing in a stacking manner the plural recording media 52, a feeding roller 53b, a retarding roller 53c for prevention of doubly feeding, a feeding guide 53d, a registration roller 53g. The feeding roller 53b is driven to rotate according to image forming operation and separately feeds the recording media 52 in the feeding cassette 53a sheet by sheet. The recording media 52 are guided by the feeding guide 53d and conveyed to the registration roller 53g via the conveyance rollers 53e, 53f.

The registration roller 53g stop rotating immediately after the recording medium 52 is conveyed, and any obliquely feeding of the recording medium 52 is corrected by the medium's hitting to the nipping portion. The registration roller 53g does, as a prescribed sequence, operation of non-rotation in which the recording medium 52 is still and waited during the image formation operation and operation of rotation in which the recording medium 52 is conveyed toward the intermediate transfer belt 54a, thereby aligning the developing agent and the recording medium 52 during the transfer process as the subsequent process.

[Process Cartridge]

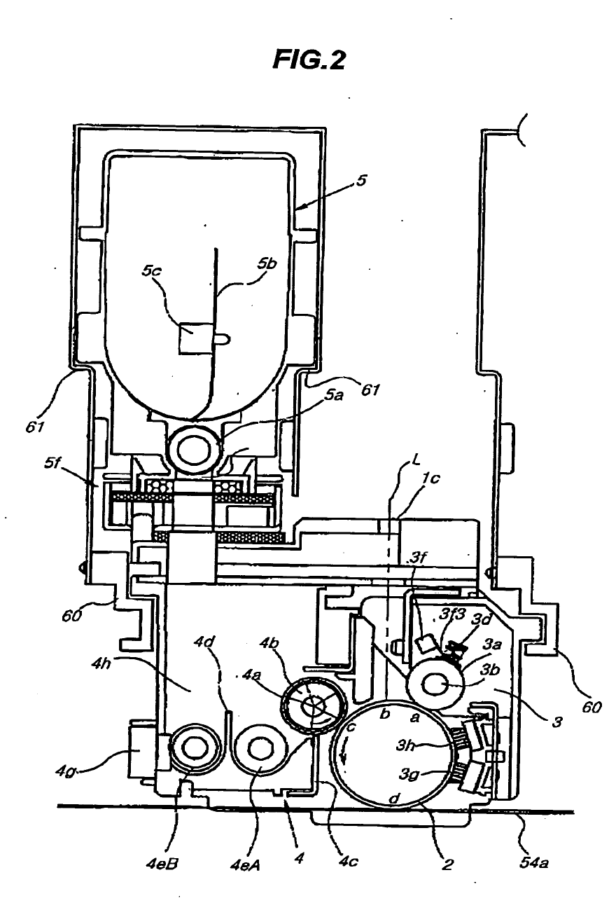

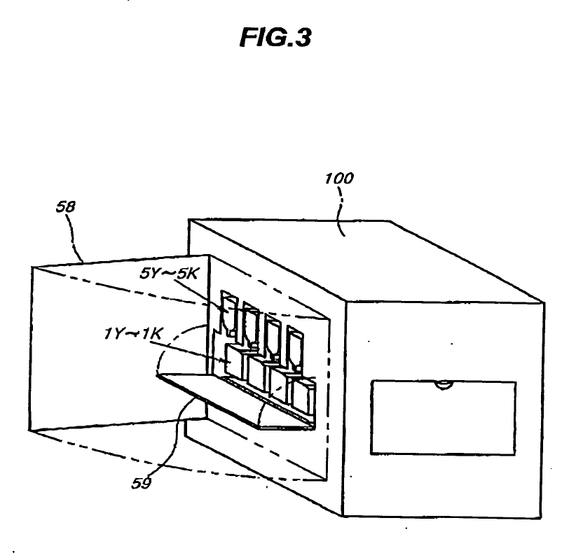

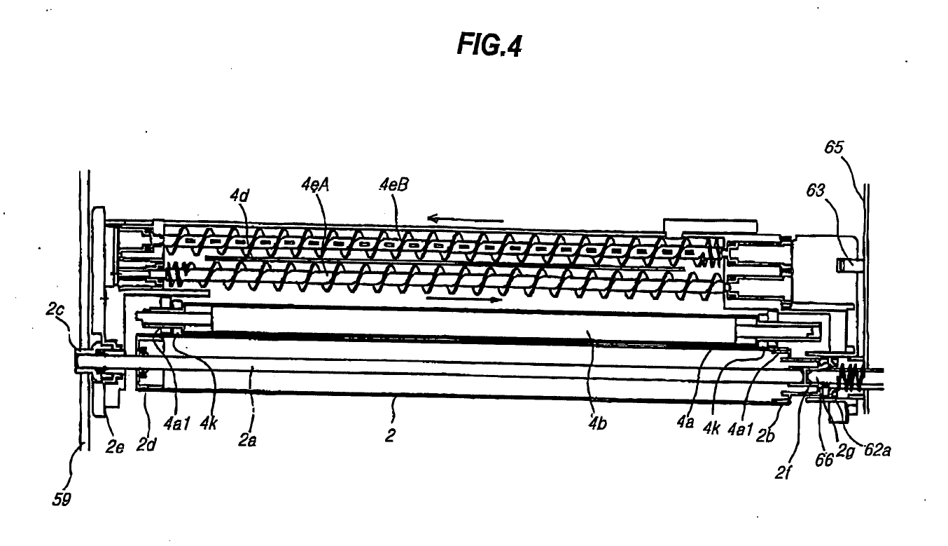

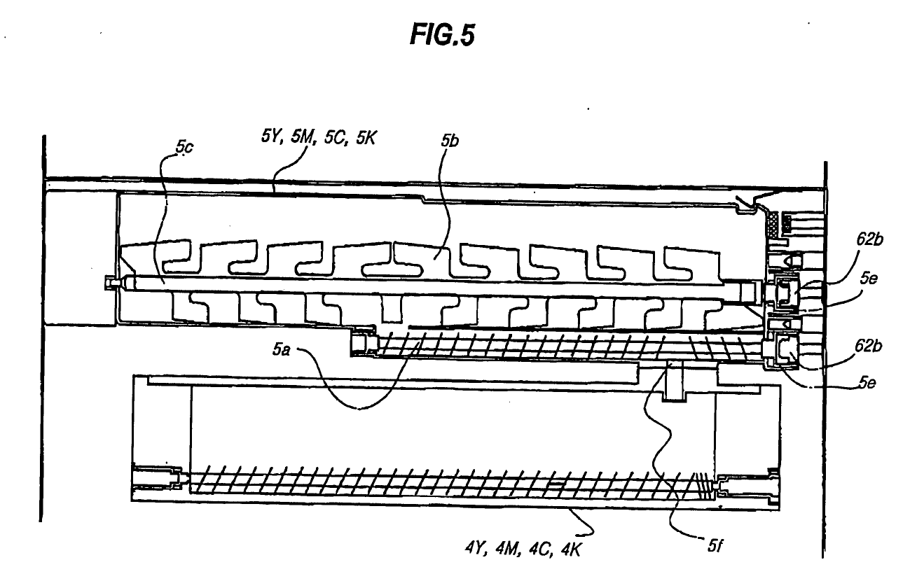

FIG. 2 is a cross section showing a process cartridge and a developing agent supplying container; FIG. 3 is an appearance perspective view showing an image forming apparatus; FIG. 4 is a cross section along a longitudinal direction showing a process cartridge; FIG. 5 is a cross section along a longitudinal direction showing a developing agent supplying container. In FIG. 2, a process cartridge 1C forming images in cyan is used as an example of the process cartridge 1.

Each of the process cartridges 1Y, 1M, 1C, 1K is constituted in a united body by arranging the charging means and the developing means around the photosensitive drum 2. The process cartridge can be detached easily by the user with respect to the apparatus body, and when the photosensitive drum 2 reaches the duration, the process cartridge is replaced. In this embodiment, e.g., where the rotation number of the photosensitive drum 2 is counted up and where the counted number exceeds the prescribed count number, it is formed that the process cartridge reaches the duration.

The photosensitive drum 2 of the embodiment is an organic photosensitive body negatively charged and has a photosensitive layer used generally on a drum base made of aluminum having a diameter of about 30 mm, and has an electric charge introduction layer at the topmost layer. The photosensitive drum 2 is driven to rotate at about 177 mm/sec as a prescribed process speed in this embodiment. The electronic charge introduction layer is made of a coated layer in which, e.g., SnO2 ultra fine particles are dispersed as conductive particles in an insulator resin binder.

As shown in FIG. 4, the drum flange 2b is secured to the rear side end of the photosensitive drum 2, and a non-drive flange 2d is secured to a front end. A drum shaft 2a penetrates the centers of the drum flange 2b and the non-drive flange 2d, and the drum shaft 2a, the drum flange 2b, and the non-drive flange 2d are rotated together. That is, the photosensitive drum 2 is rotated around the center of the shaft of the drum shaft 2a.

A front side end of the drum shaft 2a is rotatively supported to the bearing 2e, and the bearing 2e is immobilized to a bearing casing 2c. The bearing casing 2c is immobilized to a frame of the process cartridge.

[Charging Means]

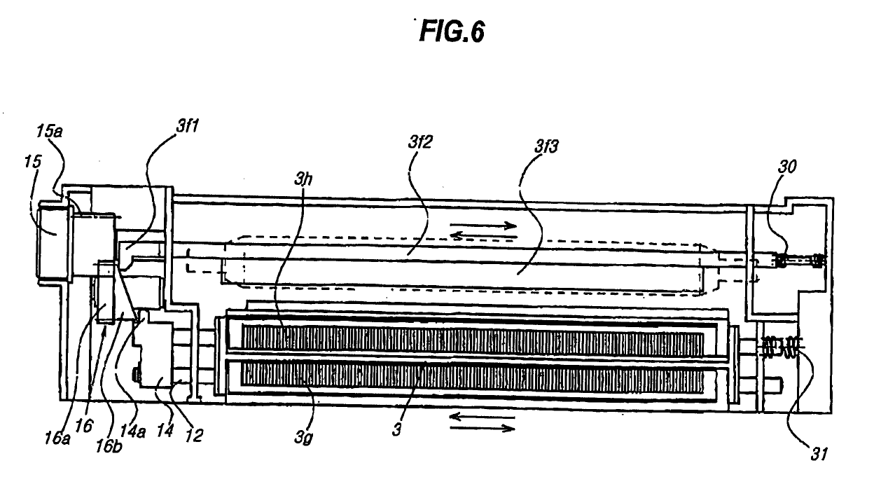

In this embodiment, the charging means is using a contact charging method, and uses, e.g., a charging roller 3a as a charging member 3a. FIG. 6 is a diagram along the longitudinal direction of the charging unit.

As shown in FIG. 2, the charging roller 3a holds the opposite ends of a core metal 3b as to be rotatable by bearings, not shown, and urges the ends by pushing springs 3d toward the photosensitive drum direction to contact with pressure to the surface of the photosensitive drum 2 with a prescribed pushing force, thereby rotating in driven by the rotation of the photosensitive drum 2.

A charging roller cleaning unit 3f near the charging roller 3a is provided. As shown in FIG. 6, the charging roller cleaning unit 3f has a flexible cleaning film 3f3. The flexible cleaning film 3f3 is disposed parallel in the longitudinal direction of the charging roller 3a; one end of the film is secured to a supporting member 3f2 moving reciprocally in a fixed amount with respect to the longitudinal direction of the charging roller 3a; the film is disposed as to form a contact nipping with the charging roller 3a at the surface around the free end side.

An arm portion 3f1 is formed at one end of the supporting member 3f2, and the arm portion 3f1 is in contact with a cam portion 16b of a cam gear unit 16 by being urged by a charging sheet returning spring 30 formed at the other end. Where rotational drive is transmitted to a coupling 15 by a drive means, not shown, from the exterior, the drive is transmitted from the coupling gear portion 16a to a cam gear 16a of the cam gear unit 16, thereby rotating the cam portion 16b. The surface of the cam portion 16b is inclined with respect to the rotary shaft, and the arm portion 3f1 moves along the surface when the cam portion 16b rotates, thereby converting the rotational drive to the reciprocal movement and rendering the supporting member 3f2 move reciprocally in the longitudinal direction of the charging roller 3a. This renders the cleaning film 3f3 rub the surface of charging roller 3a, thereby removing attachments (e.g., fine particle developing agent, additives) on the surface of the charging roller 3a.

[Non-Cleaner System]

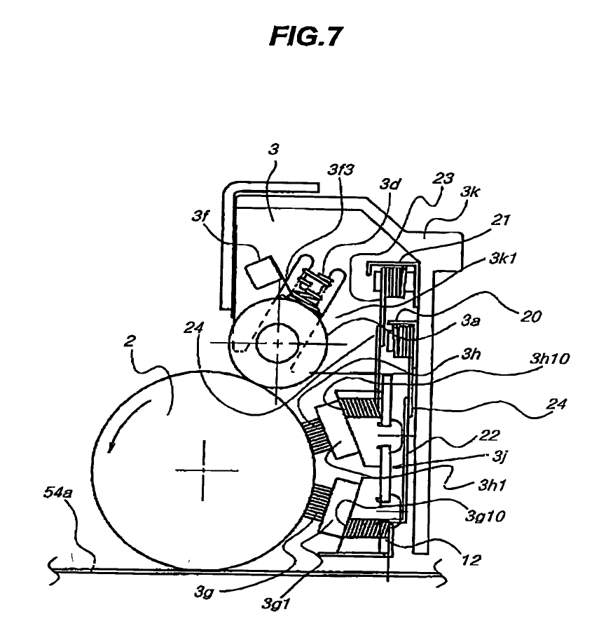

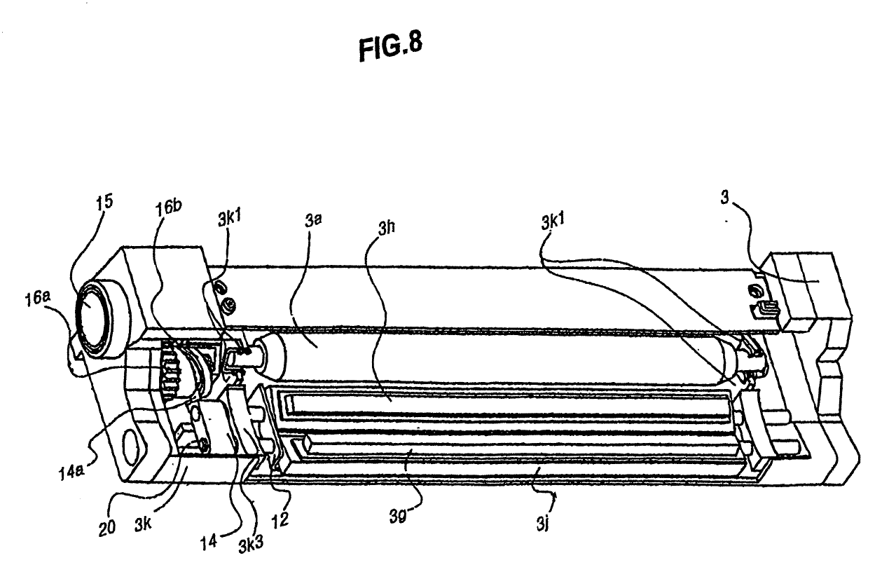

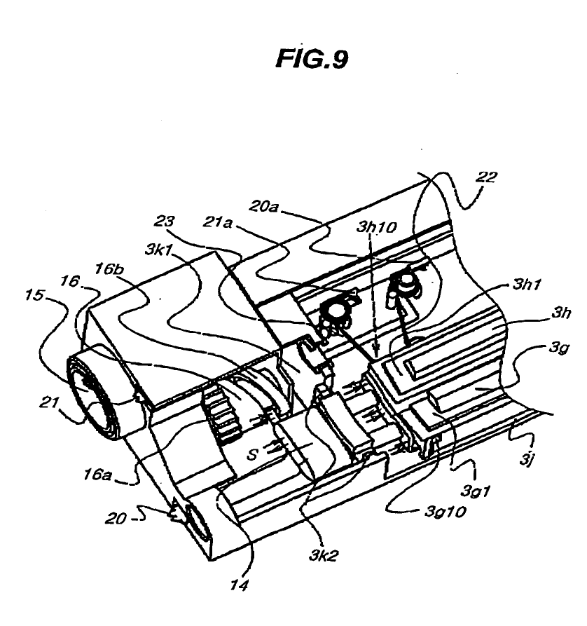

The image forming apparatus in this embodiment adapts a non-cleaner system. This non-cleaner system is described. FIG. 7 is a cross section showing the charging unit adapting a non-cleaner system; FIG. 8 is a perspective view showing the charging unit adapting the non-cleaner system; FIG. 9 is a perspective view showing a feeding contact point member and the vicinity of the charging unit.

First, the summary of the non-cleaner system in the image forming apparatus of this embodiment is described with reference to FIG. 2. The remaining developing agent image on the photosensitive drum 2 after the transfer is carried to the developing section c upon passing through the charging section a and the exposing section b according to the subsequent rotation of the photosensitive drum, and is cleaned, or namely collected, concurrently with being developed by the developing apparatus.

Since the remaining developing agent image on the surface of the photosensitive drum 2 passes through the exposing section b, the exposing step is done over the remaining developing agent image, and because the amount of the remaining developing agent image is small, large influence does not appear. The remaining developing agent image contains a normal polarity agent, a reverse polarity agent (reverse developing agent), and an agent having a small charging amount, and when the reverse developing agent and the agent having the small charging amount pass through the charging section a, the agents are adhered to the charging roller 3a, thereby getting the charging roller 3a dirty more than the permissive amount and thereby inflicting charging deflects.

In order to perform the cleaning concurrently done with development at the developing apparatus with respect to the remaining developing agent image on the photosensitive drum, it is necessary that the charging polarity of the remaining developing agent image on the photosensitive drum carried to the developing section c is the normal polarity and that the charging amount is of an amount that the electrostatic latent image on the photosensitive drum can be developed by the developing apparatus. The reverse developing agent and the developing agent of improper charging amounts cannot be collected and removed to the developing apparatus from the photosensitive drum, thereby causing defective images.

According to recent various needs of the user, by continuous printing operation or the like of the images at a high printing rate such as the photographic images, the remaining developing agent image of a large volume occurs at once, so that the above problem further becomes worse.

In this embodiment, a remaining developing agent charging amount controlling means serving as a charger to which a negative voltage applies, e.g., a blush member (hereinafter referred to as “charging controlling blush 3h”) is arranged on an upstream side in the rotation direction of the photosensitive drum 2 with respect to the charging roller 3a and on a downstream side with respect to the transfer portion d to render the charging polarity of the remaining developing agent image uniformly at the negative polarity as the normal charging polarity of the developing agent. Furthermore, a remaining developing agent image unifying mean, e.g., a blush member (hereinafter referred to as “unifying blush 3g”) is arranged on an upstream side in the rotation direction with respect to the charging controlling blush 3h and on a downstream side with respect to the transfer portion d to unify the remaining developing agent image on the photosensitive drum 2. A positive voltage applies to the remaining developing agent image unifying mean.

By forming the remaining developing agent image unifying mean, even where the remaining developing agent image on a pattern on the photosensitive drum carried from the transfer portion d to the remaining developing agent charging amount controlling means has a large amount of the developing agent, the developing agent is dispersed on the surface of the photosensitive drum and does not make any pattern. The developing agent therefore does not concentrates locally at any part of the remaining developing agent charging amount controlling means, so that normal polarity charging processing of the remaining developing agent image as a whole is done adequately by the remaining developing agent charging amount controlling means, thereby preventing the remaining developing agent image from clinging to the charging roller 3a effectively. In addition, this also prevents any ghost image of the remaining developing agent image pattern from occurring.

In this embodiment, the unifying blush 3g and the charging controlling blush 3h are blush shaped members having a proper conductivity, and are disposed so that the blush portion is in contact with the surface of the photosensitive drum. Those means move (or reciprocally move) in the longitudinal direction of the photosensitive drum by a drive source, not shown.

A mechanism of the charging unit is described. As shown in FIG. 7, the charging roller 3a is rotatively supported at a charging roller supporting portion 3k1 of a charging container 3k of the charging unit 3 constituting a part of the process cartridge as being pressed by a pushing spring 3d in a direction such that the charging roller 3a contacts to the photosensitive drum 2, and rotates as driven by the rotation of the photosensitive drum 2.

As shown in FIG. 8, a blush unit 3j is constituted by securing the unifying blush 3g and the charging controlling blush 3h to a blush supporting member 12. As shown in FIG. 9, the blush unit 3j is supported to a blush unit supporting portion 3k2 so as to be movable reciprocally with respect to the longitudinal direction of the photosensitive drum 2.

The reciprocal movement of the blush unit 3j is substantially the same as the charging roller cleaning unit 3f, and the rotational drive is transmitted from a body coupler, not shown, to a coupling 15 formed at the developing apparatus and further transmitted from a coupling gear portion 15 integrally formed to the coupling 15 via the cam gear 16a to the cam portion 16b. The cam portion 16b is arranged so that a reciprocal movement transmission arm 14 secured to an end of the blush supporting member 12 is located at the cam portion 16b, and by engaging the cam portion 16a with a protrusion 14a of the transmission arm14, the rotational drive at the cam portion 16 is converted to reciprocal movement, thereby moving reciprocally the blush unit 3j in the longitudinal direction of the charging roller 3a. In this embodiment, the unit moves reciprocally with 5 mm stroke and a constant period in a range of about 0.5 to 2.5 seconds. It is to be noted that as shown in FIG. 6, the cam portion 16 may be urged by using a returning spring 31, but as shown in FIG. 8, a protrusion 14 may be made to slide where a groove or grooves are formed at the cam portion 16.

By providing the movable mechanism as described above, the unifying blush 3g and the charging controlling blush 3h do not stably take a single position on the photosensitive drum, and therefore, even where overcharging portions or charging shortly portions exist due to resistance irregularity of the charging controlling blush 3h, the mechanism prevents the remaining developing agent image from melting and adhering to the surface of the photosensitive drum due to local overcharge of the remaining developing agent image and prevents the remaining developing agent image from clinging to the charging roller 3a due to shortage of charges or reduces such occurrences.

[Exposing Apparatus]

In this embodiment, as shown in FIG. 1, exposure to the photosensitive drum 2 is done using the laser exposing apparatus. That is, when an image signal is sent from the apparatus body, laser beam L modified corresponding to the signal is scanned to make exposure on the uniformly charged surface of the photosensitive drum 2. An electrostatic latent image is selectively formed corresponding to the image information on the surface of the photosensitive drum 2.

The laser exposing apparatus is constituted of, e.g., a solid laser device, not shown, a polygon mirror 51a, a convergence lens 51b, and a reflection mirror 51c. The solid laser device is controlled on and off as to emit and not to emit beam with a prescribed timing from a light emitting signal generator, not shown, according to the inputted image signal. The laser beam L radiated from the solid laser device is converted to a substantially parallel beam flux by a collimator lens system, not shown, and is scanned by the polygon mirror 51a rotating with a high rate. The beam is focused in a spot shape on the photosensitive drum 2 via the convergence lens 51b and the reflection mirror 51c.

An exposure profile according to the image signal is thus obtained on the surface of the photosensitive drum 2 with exposure in the main scanning direction by the laser beam scanning and exposure in the sub-scanning direction by rotation of the photosensitive drum 2. That is, by radiation and non-radiation of the laser beam L, a bright portion potential at which the surface potential is dropped and a dark portion potential at which the surface potential is not dropped are formed. The electrostatic latent image is formed corresponding to the image information by contrast between the bright portion potential and the dark portion potential.

[Developing Means]

The developing apparatus 4 as the developing means is a two-component contact developing apparatus (two-component magnetic blush developing apparatus) as shown in FIG. 2, and holds a carrier and a developing agent on a developing sleeve 4a as a developing agent carrier containing a magnet roller 4b. A limiting blade 4c is formed to the developing sleeve 4a with a prescribed gap, and according to the rotation of the developing sleeve 4a in the arrow direction, a developing agent of a thin layer is formed on the developing sleeve 4a.

The developing sleeve 4a is disposed, as shown in FIG. 4, to have a prescribed gap to the photosensitive drum 2 by rotatively fitting a spacer 4k to a journal portion 4a1 having a shorter diameter at the opposite ends, respectively. It is designed that the developing agent formed on the developing sleeve 4a during the developing operation is developed as being contacting to the photosensitive drum 2. The developing sleeve 4a is driven to rotate at a prescribed peripheral speed in the arrow direction in FIG. 2 as a counter direction to the rotation direction of the photosensitive drum 2 at the developing section.

The developing agent used in this embodiment is made of a negative charging developing agent having an average particle size of 6 microns and a magnetic carrier having an average particle size of 35 microns with a saturation magnetization of 205 emu/cm³ as a magnetic carrier. A mixture of the negative charging developing agent and the carrier with a weight ratio of 6 to 94 is used as the developing agent.

The developing agent container 4h in which the developing agent is circulating is divided into two parts by a diaphragm 4d extending in the longitudinal direction except each end Stirring screws 4eA, 4eB are disposed astride the diaphragm 4d. The developing agent supplied from the developing agent supplying container fills off at a rear side of the stirring screw 4eB as shown in FIG. 4, is stirred as fed to the front side in the longitudinal direction, and passes through a portion at which no diaphragm 4d on a front side end exists. The developing agent is further fed to the rear side in the longitudinal direction with the stirring screw 4eA, passes through a portion at which no diaphragm 4d on a rear side exists, and is stirred as fed with the stirring screw 4eB to repeat this circulation.

The developing step in which the electrostatic latent image formed on the photosensitive drum 2 is visualized using the developing apparatus 4 in the two-component magnetic blush method and a circulation system of the developing agent are described. According to the rotation of the developing sleeve 4a, the developing agent in the developing apparatus is conveyed upon sucked up to the surface of the developing sleeve 4a at a sucking up pole of the magnet roller 4b. During the midway of the conveyance, the developing agent is subject to a limitation on the thickness by a limiting blade 4c disposed perpendicularly to the developing sleeve 4a, thereby forming a thin layer developing agent on the developing sleeve 4a. When the thin layer developing agent is conveyed to the developing pole corresponding to the developing portion, standing upright phenomenon like ears is formed by magnetic force. The electrophotographic latent image on a surface of the photosensitive drum 2 is developed as a developing agent image with the developing agent in the developing agent thus formed standing upright in an ear shape. In this embodiment, the electrophotographic latent image is reverse developed.

The thin layer developing agent on the developing sleeve 4a passing the developing section subsequently enters in the developing container according to the rotation of the developing sleeve 4a, and is returned to a developing agent reservoir in the developing container upon separating from the surface of the developing agent 4a by resilient magnetic field of the conveyance pole. A direct current (DC) voltage and an alternative current (AC) voltage are fed to the developing agent 4a from the power source, not shown. In this embodiment, a DC voltage of −500 V and an AC voltage having frequency 2000 Hz and peak to peak voltage of 1500 V are applied, thereby selectively developing the exposed portions on the photosensitive drum 2.

Generally, with the two-component developing method, the developing rate increases by application of the alternative current voltage to render the images of a high quality, but there raises risks that blurring tends to occur easily. Therefore, in general, prevention of blurring is realized by providing a potential difference between the DC voltage applying to the developing sleeve 4a and the surface potential of the photosensitive drum 2. More specifically, a bias voltage is applied which is at a potential between the potential of the exposure portion of the photosensitive drum 2 and the potential of the non-exposure portion.

If the developing agent is consumed by developing operation, the developing agent concentration in the developing agent is reduced. In this embodiment, a sensor 4g is arranged at a position near the outer periphery of the stirring screw 4eB to detect the developing agent concentration. If the sensor 4g detects that the developing agent concentration in the developing agent is reduced more than a prescribed concentration level, an instruction to supply the developing agent from the developing agent supplying container into the developing apparatus 4 is made. According to this developing agent supply operation, the developing agent concentration in the developing agent is managed to be always kept at a prescribed level.

[Developing Agent Supplying Container]

The developing agent supplying containers 5Y, 5M, 5C, 5K are arranged parallel over the process cartridges 1Y, 1M, 1C, 1K, and as described above, are attached from a front side of the apparatus body 100.

As shown in ?FIG. 2, a stirring plate 5b secured to a stirring shaft 5c and a screw 5a are disposed in the developing agent supplying container, and a drain opening 5f for draining the developing agent is formed at the bottom of the container. The screw 5a and the stirring shaft 5c are rotatively supported as shown in FIG. 5, and a drive coupling (female) 5e is provided at an endmost point on one side of the screw 5a. The drive coupling (female) 5e receives drive transmission from a drive transmission (male) 62b and is rotatively driven. The contour portion of the screw 5a is in a spiral rib shape and makes reverse the screwing direction of the spiral rib at the drain opening 5f as a center.

The screw rotates in a prescribed rotation direction according to the rotation of the drive coupling (male) 62b. The developing agent is conveyed toward the drain opening 5f, and is dropped off freely through the opening of the drain opening 5f to supply the developing agent in the process cartridge. The front end in the rotation radius direction of the stirring plate is slant to contact with a certain angle to a wall of the developing agent supplying container when sliding on the wall. More specifically, by twisting and slating the front end side of the stirring plate, conveyance force toward the shaft direction is produced, thereby feeding the developing agent in the longitudinal direction.

It is to be noted that the developing agent supplying container of the embodiment is not limited to the two component developing method but can supply to a process cartridge or developing cartridge using a single component developing method, and the powder contained in the developing agent supplying container is not limited to the developing agent but also can be a so-called developing agent in which the developing agent and a magnetic carrier are mixed.

[Transfer Means]

The intermediate transfer unit 54 as a transfer means is to secondarily transfer the plural developing agent images overlapped sequentially from the photosensitive drums 2 as a primary transfer, on the recording medium 52 at once. The intermediate transfer unit 54 has an intermediate transfer belt 54a running in the arrow direction, which runs at substantially the same peripheral speed of the photosensitive drum 2 in the clockwise direction of the arrow. The intermediate transfer belt 54a is an endless belt having a peripheral length of about 940 mm, and is suspended by three rollers, a drive roller 54b, a secondary transfer facing roller 54g, and a driven roller 54c.

The primary transfer rollers 54fY, 54fM, 54fC, 54fK are disposed as rotatably at opposing positions to the photosensitive drums 2, respectively in the intermediate transfer belt 54a and is pressed toward the center direction of each photosensitive drum 2. The primary transfer rollers 54fY, 54fM, 54fC, 54fK are electrically fed from a high voltage power supply, not shown, and the developing agent on each photosensitive drum 2 is sequentially, primarily transferred on the top surface of the intermediate transfer belt 54a upon charging the belt at the opposite polarity to the developing agent from the back side of the intermediate transfer belt 54a.

The secondary transfer roller 54d serving as a transfer member comes in contact with the intermediate transfer belt 54a at a position facing to the secondary transfer facing roller 54g at the secondary transfer section. The secondary transfer roller 54d is pivotally movable in up and down direction in the drawing and rotates. A bias is concurrently applied to the intermediate transfer belt 54a at that time, and the developing agent image on the intermediate transfer belt 54a is transferred onto the recording medium 52. The intermediate transfer belt 54a and the secondary transfer roller 54d are respectively driven. When the recording medium 52 enters into the secondary transfer portion, a prescribed bias is applied to the secondary transfer roller 54d, thereby secondarily transferring the developing agent image on the intermediate transfer belt 54a to the recording medium 52. At that time, the recording medium 52 in a state sandwiched by the belt and the roller is conveyed at a prescribed speed in the left direction in the drawing concurrently subjecting to the transfer step, and is further conveyed toward the fixing device 56 as of the subsequent step.

A cleaning unit 55 capable of contacting to and separating from the surface of the intermediate transfer belt 54a is arranged at a prescribed position of the intermediate transfer belt 54 as a most downstream side of the transfer step, and removes the remaining developing agent image remaining after the secondary transfer step. A cleaning blade 55a is disposed in the cleaning unit 55 to remove the remaining developing agent image. The cleaning unit 55 is attached in a pivotally movable manner around a rotary center, not shown, and the cleaning blade 55a is in pressured contact with the intermediate transfer belt 54a in a strongly pressing direction. The remaining developing agent image taken in the cleaning unit 55 is conveyed to and stored in a waste developing agent tank, not shown, by a feeding screw 55b.

As the intermediate transfer belt 54a, usable is a polyimide resin. As other materials, not limited to the polyimide resin, favorably used are plastic materials such as polycarbonate resin, polyethylene terephthalate resin, polyvinylidene fluoride resin, polyethylene naphthalate resin, polyetherether ketone resin, polyether sulfone resin, and polyurethane resin, and rubbers of flouride system and slicone system.

[Fixing Section]

The developing agent image formed on the photosensitive drum 2 by the developing means is transferred onto the transfer material 52 via the intermediate transfer belt 54a. The fixing device 56 fixes the developing agent image transferred on the recording medium 52 using heat to the recording medium 52.

As shown in FIG. 1, the fixing device 56 includes a fixing roller 56a for applying heat to the recording medium 62, and a pressing roller 56b for pressing the recording medium 52 to contact with the fixing roller 56a, and each roller is a hollow roller. Each has a heater, not shown, inside. The rollers convey the recording medium 52 at the same time upon rotatively driven.

That is, while the recording medium 52 holding the developing agent image is conveyed with the fixing roller 56a and the pressing roller 56b, the developing agent image is fixed to the recording medium 52 in application of heat and pressure. The recording medium 52 after the fixing step is delivered by delivery rollers 53h, 53j and stacked on a delivery tray 57 on the apparatus body 100.

[Attachment of Process Cartridge and Developing Agent Supplying Container]

Next, attachment steps of the process cartridge and the developing agent supplying container are described in use of FIG. 2, FIG. 3, and FIG. 4. As shown in FIG. 3, an openable front door 58 is disposed on a front side of the apparatus body 100, and when the front door 58 is pulled to open, an opening for inserting the process cartridges 1Y to 1K and the developing agent supplying containers 5Y to 5K is exposed. A core setting plate 59 rotatively supported is disposed at the opening for inserting the process cartridge 1, and in a case where the process cartridge 1 is inserted or pulled out, this operation is to be done after releasing the core setting plate 59.

As shown in FIG. 2, in the apparatus body 100, a guide rail 60 for guiding the attachment of the process cartridge 1, and a guide rail 61 for guiding the attachment of the developing agent supplying container 5 are secured. The attachment direction of the process cartridge 1 and the developing agent supplying container 5 is a direction parallel to the axial direction of the photosensitive drum 2, and the guide rails 60, 61 are disposed in substantially the same direction. The process cartridge 1 and the developing agent supplying container 5 are inserted as once sliding from the front side to the rear side in the apparatus body 100 along the guide rails 60, 61.

As shown in FIG. 4, when the process cartridge 1 is inserted to the rearmost portion, a core setting shaft 66 of the apparatus body is inserted into a center hole 2f of the drum flange 2b, thereby setting the rotational center position on a rear side of the photosensitive drum 2 with respect to the apparatus body. At the same time, the drive transmission portion 2g formed at the drum flange 2b and the drive coupling (male) 62g are coupled to allow the photosensitive drum 1 to be rotatably driven. The drive transmission portion 2g used in this invention is in a twisted triangular prism shape, to which the drive is transmitted by application of drive force from the apparatus body, and generates a force pulling the photosensitive drum 2 rearward.

A supporting pin 63 for positioning the process cartridge 1 is disposed at a rear side plate 65, and the supporting pin 63 is inserted in a frame of the process cartridge, thereby securing the position of the frame of the process cartridge.

The core setting plate 59 rotatable is disposed on a front side of the apparatus body 100, and with respect to the core setting plate 59, the bearing casing 2c of the process cartridge 1 is fixedly supported. According to the series of the insertion operations, the photosensitive drum 2 and the process cartridge 1 are positioned with respect to the apparatus body 100.

On the other hand, the developing agent supplying container 5 is secured to the supporting pin 64 projecting from the rear side plate 65 when inserted up to the rearmost portion. At the same time, the drive coupling (female) 5e and the drive coupling (male) 62b are coupled to each other, thereby allowing rotational drive of the screw 5a and the stirring shaft 5c.

[Electric Contact Point Member]

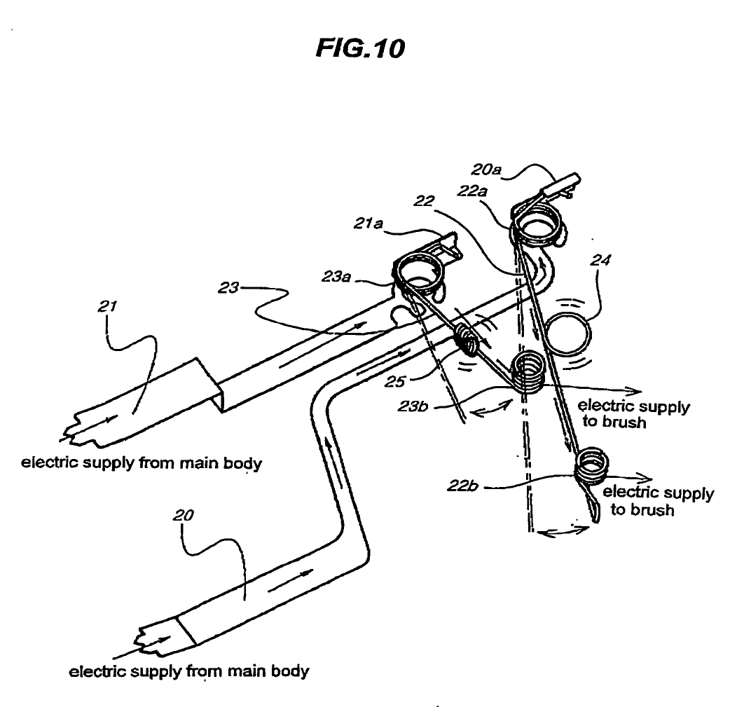

Next, an electrically feeding contact member as an electric contact point member in the charging unit having the above structure is described using FIG. 7, FIG. 8, FIG. 9, and FIG. 10. FIG. 10 is a perspective view showing a feeding metal plate for blush feeding and a blush feeding contact point member.

As shown in FIG. 7, FIG. 8, as described above, the unifying blush 3g as an example of the remaining developing agent image unifying means as a charger, and the charging amount controlling blush 3h as an example of the remaining developing agent image charging amount controlling means as a charger are secured to the blush supporting member 12 in the charging unit 3 constituting a part of the process cartridge 1, and are disposed reciprocally movable as the blush unit 3j. The function of the non-cleaner system can be done by feeding stably from the apparatus body to the unifying blush 3g and the charging controlling blush 3h of the blush unit 3j reciprocally movable.

As shown in FIG. 7, FIG. 9, feeding is made to the unifying blush 3g form the apparatus body via a first feeding plate 20, and a first feeding contact point member 22 as a first electrically contact point member. In substantially the same way, feeding is made to the charging controlling blush 3h via a second feeding plate 21, and a second feeding contact point member 23 as a second electrically contact point member. The first feeding plate 20 secured to the charging container 3k is fed by the power source as a voltage applying means formed at the apparatus body, and is connected to the first feeding contact point member 22 at a contact point portion 20a (see, FIG. 9). The first feeding contact point member 22 is connected to a contact point portion 3g10 (see, FIG. 7), and feeding is made from the back surface of a metal plate base 3g1 to the unifying blush 3g. In substantially the same way, the second feeding plate 21 secured to the charging container 3k is fed by the power source of the apparatus body, and is connected to the second feeding contact point member 23 at a contact point portion 21a (see, FIG. 9). The second feeding contact point member 23 is connected to a contact point portion 3h10 (see, FIG. 7), and feeding is made from the back surface of a metal plate base 3hl to the charging controlling blush 3h.

FIG. 10 illustrates only the first feeding plate 20, the second feeding plate 21, the first feeding contact point member 22 extending linearly, and the second feeding contact point member 23 extending linearly. The first and second feeding contact point members 22, 23 are in a linear shape, and therefore, it is advantageous because no large load is exerted mechanically when a voltage is supplied to the blushes 3g, 3h. Although a positive voltage is applied to the first feeding contact point member 22 whereas a negative voltage is applied to the second feeding contact point member 23, the distance between the first feeding contact point member 22 and the second feeding contact point member 23 in the left and right direction in FIG. 7 (or a direction perpendicular to the longitudinal direction of the photosensitive drum) can be maintained at a distance not electrical leaking between the members because the members are in the linear shape, so that a further compact space is possible.

As shown in FIG. 10, the opposite ends of the first feeding contact point member 22 are formed at a torsion spring 22a as a fig portion and a coil spring 22b as a portion moving reciprocally. In substantially the same way, the opposite ends of the second feeding contact point member 23 are formed at a torsion spring 23a as a fixing portion and a coil spring 23b as a portion moving reciprocally.

With this structure, the feeding contact point members 22, 23 can be transformed according to the blush unit 3j reciprocally moving, so that feeding can be made always.

However, where the blush unit 3j move reciprocally, the feeding contact point members 22, 23 receive the load repeatedly. Particularly, because the distance between the opposite ends of the feeding contact point members 22, 23 may vary in association with the reciprocal movement of the blush unit 3j, the torsion spring and the coil spring may not correspond to the change in terms of the mechanism, so that the load exerted to the members may become so large. Where the members are used for a long period of time, the feeding contact point members 22, 23 may be broken or dropped, and charging defects or collection defects may occur due to feeding shortage to the unifying blush 3g and the charging controlling blush 3h.

To recoup this problem, as shown in FIG. 10, in this embodiment, a ring shaped elastic torsion spring 24 as a buffer portion as an example of a buffering mechanism is formed between the torsion spring 22a at the securing portion on the power source side and the coil spring 22b at the moving portion on the charger side in the first feeding contact point member 22. In the second feeding contact point member 23, a ring shaped elastic torsion spring 25 as a buffer portion as an example of a buffering mechanism is formed between the torsion spring 23a at the securing portion on the power source side and the coil spring 23b at the moving portion on the charger side.

It is to be noted that the buffering mechanism is not limited to the torsion spring and the coil spring, a member having an elastic shape with elasticity to the distance between the opposite ends of the feeding contact point members 22, 23 may be used. Accordingly, for example, a bending portion in a mountain shape, a wave shape, and a saw shape may be formed at an intermediate portion of the feeding contact point members 22, 23, or a large curving between the opposite ends may take advantages of the invention though with a simpler structure.

As described above, the electric contact point member, the process cartridge, and the image forming apparatus according to the invention can buffer repetitive loads exerted to the electric contact point member with a very simple structure but without inviting increase of the part number, thereby preventing the electric contact point member from receiving damages or dropping off. Therefore, surely feeding can be made to the remaining developing agent charging amount controlling means and the remaining developing agent image unifying means, so that charging defects or collection defects of the remaining developing agent can be prevented.

1. An electric contact member applying a voltage from a voltage applying means to a charger reciprocally moving in a longitudinal direction of an image carrier, comprising:
a securing portion electrically connected to a side of the voltage applying means;
a reciprocally movable moving portion connected electrically to a side of the charger; and
a buffer portion formed between the securing portion and the moving portion.

2. The electric contact member according to claim 1, wherein the buffer portion has an elasticity.

3. The electric contact member according to claim 1, wherein the buffer portion is in a ring shape.

4. The electric contact member according to claim 1, wherein the buffer portion has a torsion spring portion.

5. The electric contact member according to claim 1, wherein the buffer portion has a coil spring portion.

6. The electric contact member according to claim 1, wherein at least one of the securing portion and the moving portion has a torsion spring portion.

7. The electric contact member according to claim 1, wherein at least one of the securing portion and the moving portion has a coil spring portion.

8. The electric contact member according to any of claims 1 to 7, wherein the electric contact member is in a linear shape.

9. A process cartridge detachably attached to a body of an image forming apparatus, comprising:
an image carrier;
a charger reciprocally moving in a longitudinal direction of the image carrier; and
an electric contact member for applying a voltage from a voltage applying means to the charger, the electric contact member comprising:
a securing portion electrically connected to a side of the voltage applying means;
a reciprocally movable moving portion connected electrically to a side of the charger; and a buffer portion formed between the securing portion and the moving portion.

10. The process cartridge according to claim 9, wherein the charger charges a developing agent remaining on the image carrier.

11. The process cartridge according to claim 10, wherein the charger is placed on a downstream side of a transfer position for transferring a developing agent image from the image carrier to the transfer member and on an upstream side of a charging means for charging the image carrier, in the moving direction of the image carrier.

12. The process cartridge according to claim 9, wherein the charger moves reciprocally as in contact with the image carrier.

13. The process cartridge according to claim 12, wherein the charger has a brush member in contact with the image carrier.

14. The process cartridge according to claim 9, wherein the buffer portion has an elasticity.

15. The process cartridge according to claim 9, wherein the buffer portion is in a ring shape.

16. The process cartridge according to claim 9, wherein the buffer portion has a torsion spring portion.

17. The process cartridge according to claim 9, wherein the buffer portion has a coil spring portion.

18. The process cartridge according to claim 9, wherein at least one of the securing portion and the moving portion has a torsion spring portion.

19. The process cartridge according to claim 9, wherein at least one of the securing portion and the moving portion has a coil spring portion.

20. The process cartridge according to claim 11, wherein the process cartridge has a developing means for forming a developing agent image on the image carrier, and wherein the developing means can collect a remaining developing agent on the image carrier.

21. The electric contact member according to any of claims 9 to 20, wherein the electric contact member is in a linear shape.

22. An image forming apparatus comprising:
an image carrier;
a charger reciprocally moving in a longitudinal direction of the image carrier; and
an electric contact member for applying a voltage from a voltage applying means to the charger, the electric contact member comprising:
a securing portion electrically connected to a side of the voltage applying means;
a reciprocally movable moving connected electrically to a side of the charger; and
a buffer portion formed between the securing portion and the moving portion.

23. The image forming apparatus according to claim 22, wherein the charger is placed on a downstream side of a transfer position for transferring a developing agent image from the image carrier to the transfer member and on an upstream side of a charging means for charging the image carrier, in the moving direction of the image carrier and charges a developing agent remaining on the image carrier, wherein the apparatus has a developing means for forming a developing agent image on the image carrier, and wherein the developing means can collect a remaining developing agent on the image carrier.

24. The image forming apparatus according to claim 22, wherein the buffer has an elasticity.
